(19) United States
(12) Patent Application Publication
(10) Pub. No.: US 2011/0041933 A1
(43) Pub. Date: Feb. 24, 2011

(54) Pressurized Gas Reciving Device, Dispenser-Receiving Device Assembly, and Corresponding Supply System

(76) Inventors: Philippe Pisot, L'Isle Adam (FR); Alessandro Moretti, Brescia (IT); Renaud Ligonesche, Herblay (FR); Antonie Frenal, Ezanville (FR)

Correspondence Address: American Air Liquide, Inc.;Intellectual Property Dept., 2700 Post Oak Boulevard, Suite 1800, Houston, TX, 77056, US

(21) Appl. No.: 12/989,172

(22) PCT Filed: Apr. 16, 2009
(86) PCT No.: PCT/FR2009/050704

§ 371 Date: Oct. 22, 2010

(30) Foreign Application Priority Data
Apr. 24, 2008 (FR) 0852756

(51) Int. Cl. F15D 1/00

(52) U.S. Cl. 137/561 R; 137/798

(57) ABSTRACT

The invention relates to a pressurized gas receiving device, particularly for a gas consumer such as an engine or a fuel cell, including a connection interface comprising at least one coupling member intended for selectively coupling with a coupling member combined with a gas dispenser, said receiving device including a movable gas intake shaft defining a gas flow duct, said duct having at least one downstream end to be connected to a consumer and one upstream end to be connected to a gas dispenser, the intake shaft being selectively movable relative to the coupling part between at least two stable positions: a first downstream reference position and a second upstream protruding position.

The present invention relates to a pressurized gas receiving device, an assembly comprising a gas dispenser and a receiving device and a gas supply system using such an assembly.

The invention relates more particularly to a receiving device for pressurized gas, notably for a gas consumer such as an engine or a fuel cell, comprising a connection interface comprising at least one coupling member designed to interact selectively in coupling with a coupling member joined to a gas dispenser.

The invention relates notably to the supply of gas-consuming devices, such as a fuel cell or a heat engine for a vehicle in which the fuel contains for example hydrogen gas stored in tanks at very high pressure (up to 700 bar and above). The lack of infrastructures allowing the resupply with fuel directly to the vehicle results in envisaging alternative solutions which consist in having the users exchange empty tanks for full tanks.

Current or future regulations predict the necessity to fit the hydrogen gas tanks with automatic isolation valves making it possible to close the supply circuit for the fuel cell or for the heat engine directly at the source of gas.

One object of the invention is to propose a technical solution to this regulatory constraint in the event that the resupply of the vehicle is carried out by exchanging empty tanks for full tanks while maintaining a very high safety level.

In the case of vehicles fitted with fixed onboard tanks, a known solution consists in providing a high-pressure solenoid valve directly at the tank outlet. This satisfies the requirement to provide an automatic isolation device as close as possible to the gas source as required by the regulations. One drawback of this solution is that the lack of infrastructure for resupplying with gaseous fuel vehicles with fixed onboard tanks does not favor this technical solution.

Accordingly, the invention also proposes associating a removable pressurized gas tank with a system for receiving said fixed onboard tank onboard the user (the vehicle for example).

Preferably, the removable pressurized gas tank is fitted with a gas dispenser (such as a valve, notably a valve with integrated relief valve). The gas dispenser comprises at least one gas isolation means such as an isolation valve element.

The receiving device, for example on board a vehicle, comprises an interface capable of interacting with the tank (more precisely with the dispenser). The receiving device also comprises a system for controlling the opening of the isolation valve element(s) of the dispenser.

Preferably, the system for controlling the opening of the dispenser valve can be actuated automatically (and/or manually) by an actuator that can be remote.

One object of the present invention is to alleviate all or some of the drawbacks of the prior art listed above.

For this purpose, the receiving device according to the invention, moreover according to the generic definition given to it by the above preamble, is essentially characterized in that the receiving device comprises a movable gas inlet spindle defining a flow channel for the gas, said channel having at least one downstream end designed to be connected to a consumer and one upstream end designed to be connected to a gas dispenser, the inlet spindle being selectively movable relative to the coupling member between at least two stable positions: a first downstream reference position and a second position advanced in the upstream direction.

Moreover, embodiments of the invention may comprise one or more of the following features:
the receiving device comprises a stopper that is selectively movable between a first position interrupting the flow of gas between the upstream end and downstream end of the channel and a second position allowing the flow of gas between the upstream end and downstream end of the channel,
the movable stopper is by default automatically forced toward its first position, for example via a return element,
the movable stopper is formed so as to be moved toward its second position by direct or indirect mechanical contact with a gas dispenser and/or manually and/or by a remote-control actuator,
the movable stopper is formed in order to be moved automatically toward its second position when the receiving device is coupled to a gas dispenser,
the flow channel comprises two separate distinct portions, the stopper forming a movable linking chamber selectively placing or not placing in fluidic communication ends of the two portions of the channel,
the inlet spindle can be moved in translation between the first downstream reference position and the at least second, advanced upstream, position under the action of a lever or of an operating cam,
the inlet spindle is, by default, forced toward its first downstream reference position by a return member,
the stopper can be moved in translation concentrically with the dispenser spindle, a spacing between the stopper and the inlet spindle and a sealing system delimiting a movable connecting chamber capable of selectively placing or not placing in fluidic communication ends of the two portions of the flow channel.

The receiving device is formed (selectively mobile inlet spindle) in order to control, for example, multiple and sequential receipts of gas from at least one gas dispenser which can be removable (exchangeable gas bottle).

The invention may also relate to an assembly comprising a dispenser of pressurized gas such as a valve comprising a coupling member, and a receiving device for pressurized gas.

The assembly may be characterized in that:
the gas dispenser comprises a circuit for dispensing gas to the receiving device furnished with a first and a second valve element placed in series, and in that the inlet spindle is of a size such that, when the receiving device is in the coupling position on the gas dispenser, the first valve element of the gas dispensing circuit is actuated to open by the inlet spindle placed in its first downstream reference position, or respectively the first valve element of the gas dispensing circuit is actuated to open by the inlet spindle only when the latter is placed in its second upstream reference position,
the inlet spindle can be movable into a third position advanced further upstream than the second upstream position and can be of a size such that, when the receiving device is in the coupling position on the gas dispenser, the first valve element of the gas dispensing circuit is not actuated to open by the inlet spindle placed in its first downstream reference position, in its second position advanced upstream, the inlet spindle actuating only the opening of the first valve element of the dispensing circuit, in its third position advanced upstream, the inlet spindle actuating the opening of the first valve element and of the second valve element of the dispensing circuit,
the sealing system supported by the receiving device and/or the dispenser comprises at least one O-ring placed in the dispenser and formed to create a seal concentric with the dispensing spindle, between, on the one hand, an upstream orifice of the inlet spindle communicating with the flow channel for the gas and, on the other hand, the downstream end of the channel,
the inlet spindle selectively actuates the opening of the second valve element of the gas dispensing circuit via an intermediate member such as a valve actuator, for example via the body of the first valve element,
the system for supplying pressurized gas to a user comprises several pressurized gas tanks connected to the user via respective gas-dispenser and receiver-device assemblies and in that said tanks supply the user sequentially.

The invention may also relate to a system for supplying pressurized gas to a gas user from at least one pressurized gas tank, each tank comprising a pressurized gas dispenser such as a valve, the user being able to be selectively connected to each dispenser via a respective receiving device, characterized in that the assembly or assemblies each comprising a gas dispenser and a receiving device comply.

The invention may also relate to an assembly comprising a circuit of use (in the receiving device) and a pressurized gas receptacle furnished with a pressurized gas dispenser (valve or device for filling and dispensing gas) in which the use circuit comprises a mechanism forming a high-pressure safety valve capable of discharging pressurized exhaust gas from the dispenser to the atmosphere or a determined secure zone.

Preferably the dispenser comprises two valve elements.

Accordingly the use circuit (in the receiving device) comprises a member such as a spindle having a first selective open position of the first valve element (second valve element closed) and a second open position of the first valve element and of the second valve element.

As a variant, it is possible to envisage that, in a first position, the spindle opens no valve element, and then opens a first of the two valve elements in a second position and then finally opens the two valve elements in series in a third position.

The invention may also relate to an alternative device or method comprising any combination of the features above or below.

Other particular features and advantages will appear on reading the following description made with reference to the figures in which:

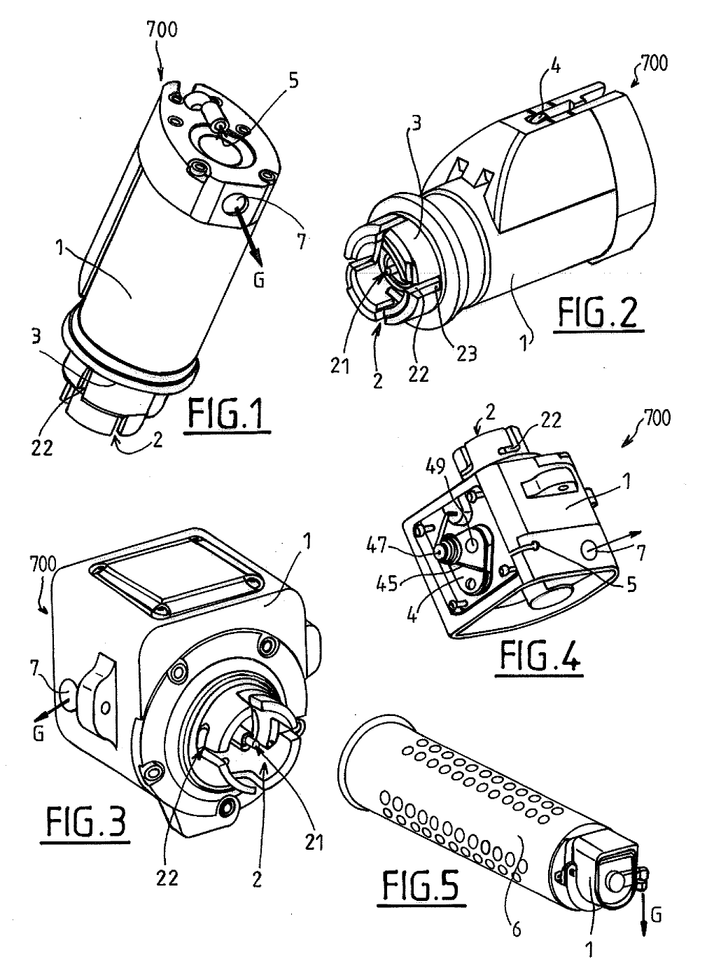

FIGS. 1 and 2 represent views that are external and in isometric perspective of an exemplary embodiment of a receiving device for a gas tank according to the invention,

FIGS. 3 and 4 represent views that are external and in isometric perspective of another embodiment of a receiving system according to the invention,

FIG. 5 is a view that is external and in isometric perspective of the embodiment of FIGS. 3 and 4 in a configuration mounted in a containment sheath,

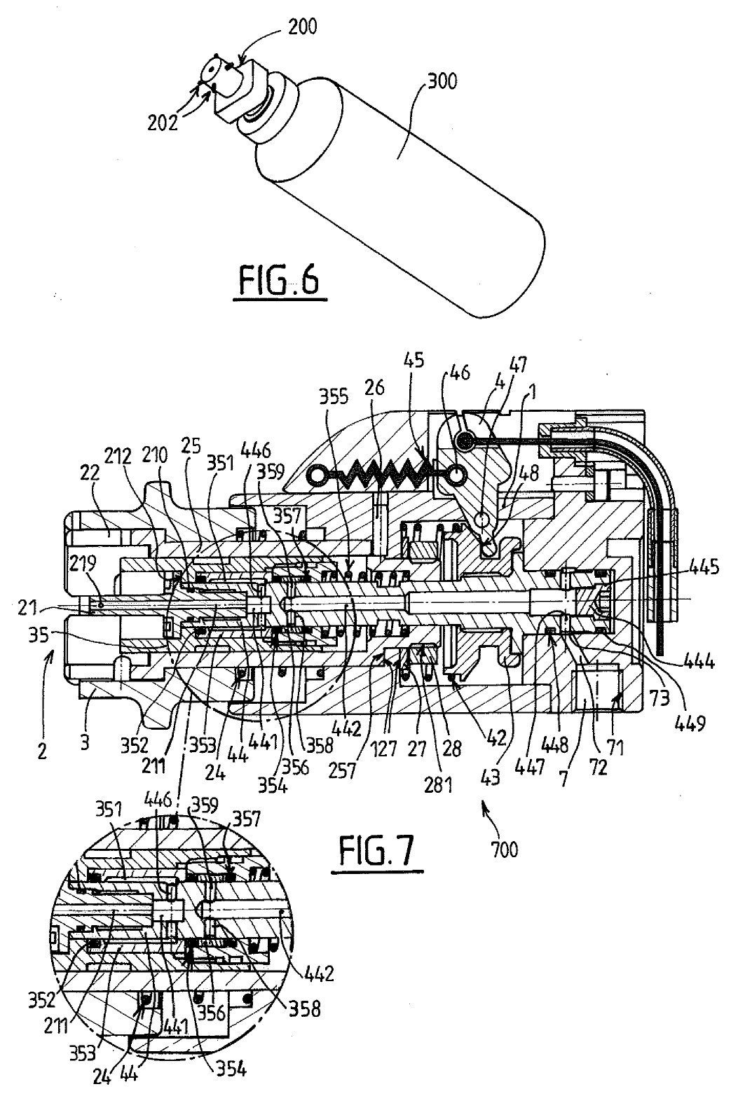

FIG. 6 is a view in isometric perspective of a tank fitted with an exemplary gas dispenser compatible with the receiving devices of FIGS. 1 to 4,

FIG. 7 is a view in longitudinal section of the receiving device of FIGS. 1 and 2 in a disconnected configuration at rest,

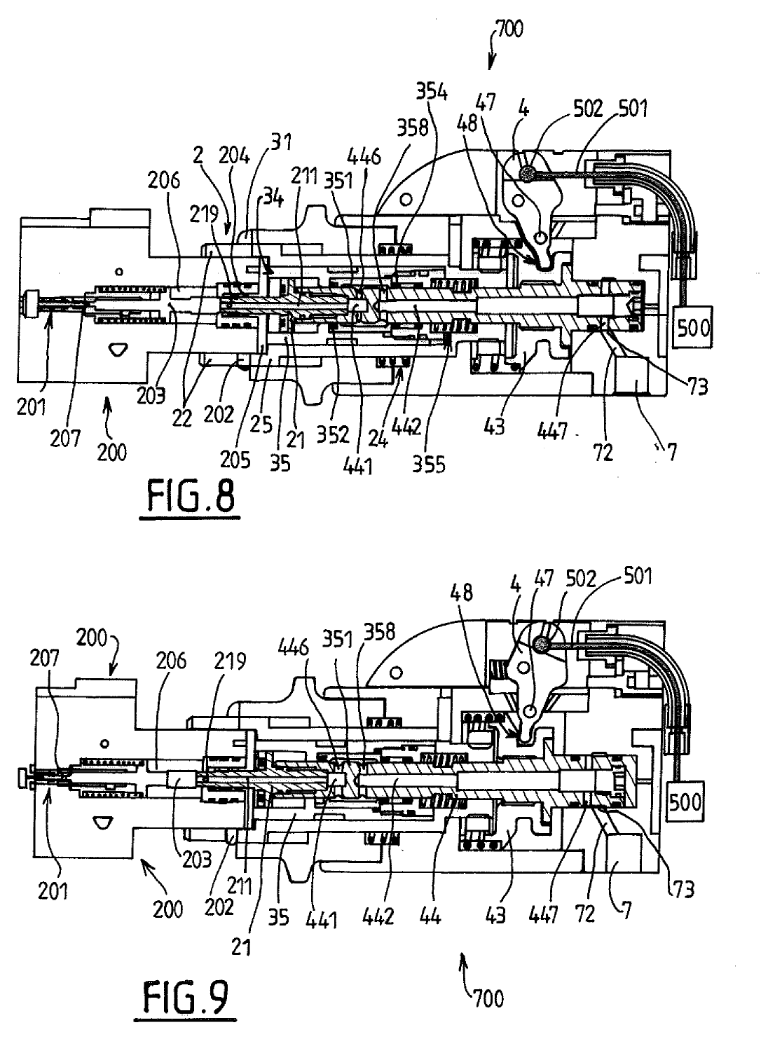

FIG. 8 is a view in longitudinal section of the embodiment of the receiving device of FIGS. 1 and 2 in a configuration connected to a gas tank and in the “single open” position,

FIG. 9 is a view in longitudinal section of the embodiment of the receiving device of FIGS. 1 and 2 in a configuration connected to a gas tank and in the “double open” position,

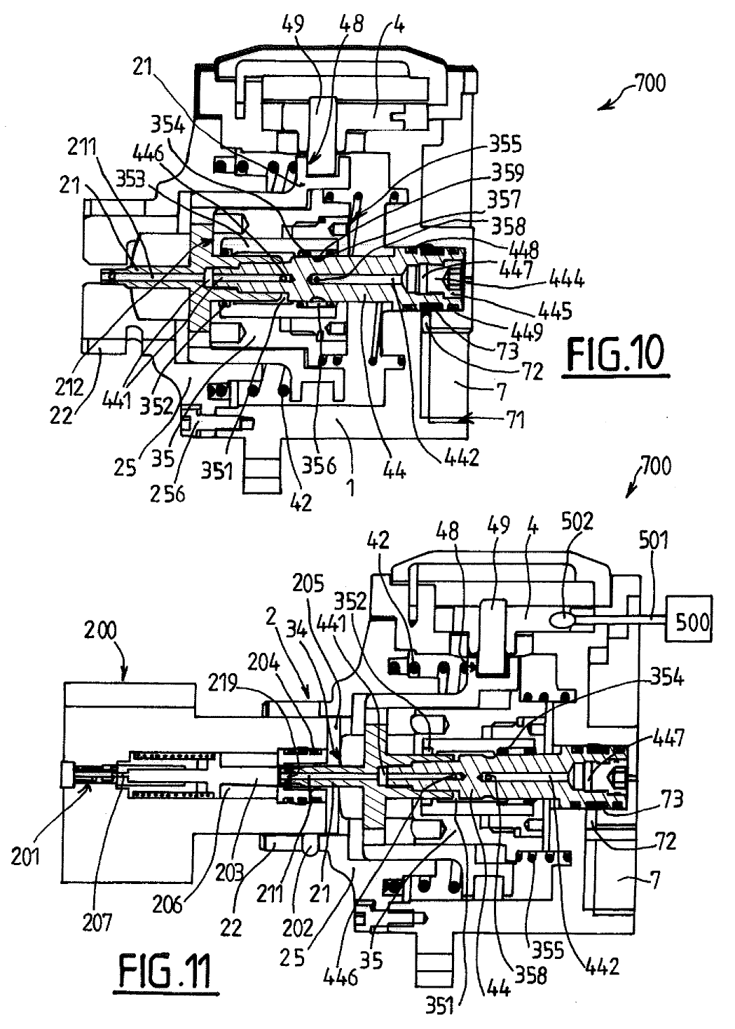

FIG. 10 is a view in longitudinal section of the receiving device of FIGS. 3 and 4 in a disconnected configuration at rest,

FIG. 11 is a view in longitudinal section of the receiving device of FIGS. 3 and 4 in a configuration connected to a gas tank and in the “single open” position,

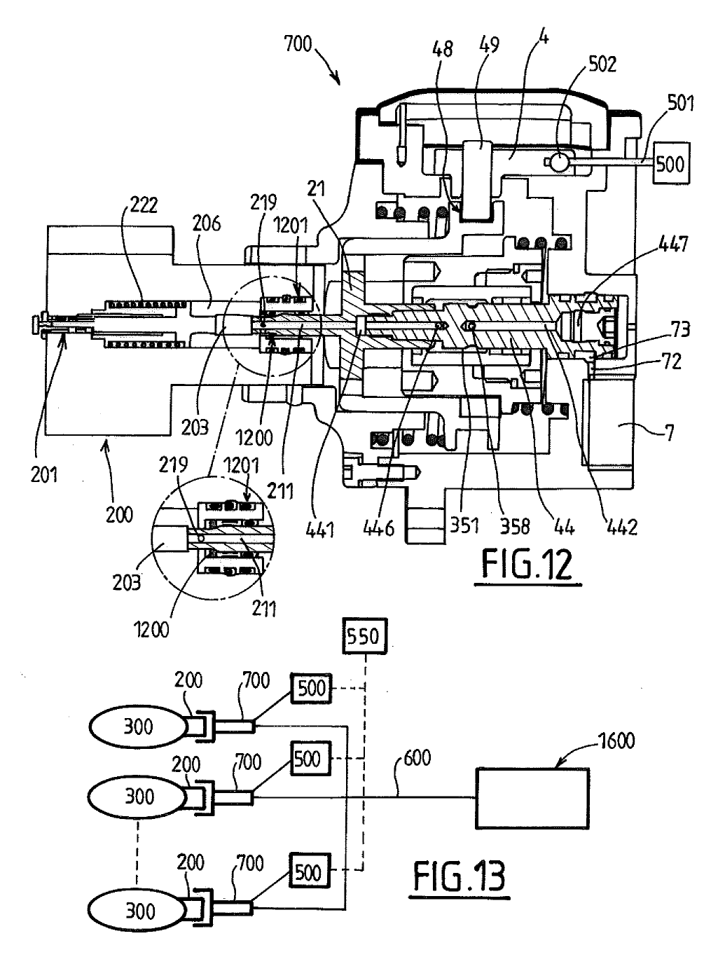

FIG. 12 is a view in longitudinal section of the receiving device of FIGS. 3 and 4 in a configuration connected to a gas tank and in a “double open” position,

FIG. 13 represents schematically and partially an example of a system for supplying pressurized gas to a user using a receiving device according to the invention,

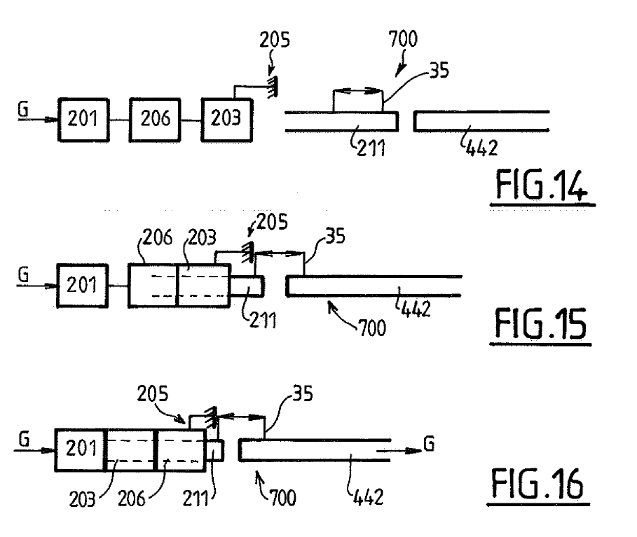

FIGS. 14 to 16 illustrate schematically and partially the structure and the operation of the receiving device with a dispenser respectively in the “disconnected at rest”, then “connected and in the single open position” and then the “connected and in the double open position” configuration.

FIGS. 1 and 2 represent a receiving device 700 for a gas tank 300 fitted with a gas dispenser 200 (such as a valve) (see FIG. 6). The receiving device 700 comprises, for example, a body 1 a downstream end of which comprises a connector 7 allowing a sealed connection with a user system 1600 (see FIG. 13). An upstream end of the receiving device 700 comprises a connection interface 2 having a mechanical locking system 22 making it possible to sealingly couple the receiving device 700 to a gas dispenser 200 mounted on a tank 300. The mechanical locking system 22 may comprise grooves designed to interact with spindles or bayonets 202 of a dispenser (connection of the bayonet type). Naturally, any other type of coupling can be envisaged.

The control for unlocking the coupling of the receiving device 700 on a dispenser 200 takes the form of the movable ring 3 situated coaxially with the body 1. The locking ring 3 provides a removable locking of the bayonets 202 in the grooves 22.

The upstream end of the device 700 also comprises a tubular fluid-inlet spindle 21 defining an internal channel for the gas.

The embodiment of FIGS. 1 and 2 is preferably intended for applications using heavy and bulky tanks, in which the receiving device 700 is brought to the tank by the user.

FIG. 7 illustrates a view in longitudinal section of the receiving device 700 not disconnected from a dispenser 202 of a tank and at rest. The connector 7 (for example female) may comprise a conical female tapping 71 allowing a sealed connection of the receiving device 700 with a supply circuit of the application or user.

The coupling members 22 (grooves or similar elements) are for example formed at the upstream end of a connection flange 25 of generally tubular shape mounted on the body 1.

The flange 25 is for example prevented from rotating relative to the body 1 by virtue of a pin 26. The flange 25 is for example connected in translation to the body 1 via a nut 28 which traps a shoulder 127 of the body 1 between a washer 27 and a surface 257 of the connection flange 25.

The movable locking ring 3 can slide without rotating about the connection flange 25. A return spring 24 placed around the flange 25 constantly returns the movable ring 3 to the locked position in the upstream direction.

The upstream end of the inlet spindle 21 is secured (for example by screwing) to a downstream inlet spindle 44 which can translate inside the receiving device 700. The translation of the inlet spindle (assembly 44, 21) in the body 1 is controlled for example by a lever 4. The lever 4 has for example a rotation spindle 47 mounted on the body 1.

For example, the lever 4 is in tangential contact 48 with a ring 43 screwed onto the downstream portion of the movable spindle 44. The position of the movable spindle 44 in FIG. 7 is normally stable and is the result of a balance between, on the one hand, the force of a return spring 42 forcing the ring 43 downstream and, on the other hand, the force of a return spring 45 forcing the lever 4 upstream, in contact with the ring 43.

The inlet spindle 21, 44 is terminated at its upstream end by a point in the form of a tubular needle 21 (it is possible to envisage forming the two portions 21 and 44 of the inlet spindle in a single piece. In the rest of the description, any one or both of the two spindles 21, 44 will be designated without distinction by the general term “inlet spindle” or simply “spindle”).

The seal between these spindles 21, 44 can be provided by the O-ring 210. The downstream end of the inlet spindle 44 is closed for example by a plug 444 that is screwed in and made gastight for example by an O-ring 445.

A channel or duct 211 traverses the inlet spindle 21 and emerges in a chamber 441 of the spindle 44. At this chamber 441, the inlet spindle 44 comprises first radial orifices 446 communicating with an upstream annular chamber 351. The upstream annular chamber 351 is formed between the body of the inlet spindle 44 and an upstream tubular spacer 353. The upstream annular chamber 351 is also delimited upstream and downstream respectively by two O-rings 352 and 354 secured to a stopper 35.

The stopper 35 of generally tubular shape is mounted so as to slide about the spindle 21, 44 and about the upstream spacer 353. The stopper 35 can therefore translate about the inlet spindle 21, 44. The stable rest position of the stopper 35 is shown in FIG. 7. In this stable rest position, a return spring 355 pushes the stopper 35 in the upstream direction against an abutment surface 212 of the spindle 21.

The stopper 35 may comprise a second downstream annular chamber 359 delimited by a second downstream spacer 356 and two other respective O-rings 354, 357.

The two annular chambers, the upstream chamber 351 and downstream chamber 359, are separated by an O-ring 354. Second radial orifices 358 are formed in the movable inlet spindle 44. These second radial orifices 358 are, in the configuration of FIG. 7, in communication with the downstream annular chamber 359 and emerge into a central channel 442 formed in the body of the inlet spindle 44.

This inlet channel 442 is extended downstream by the radial holes 447. The radial holes 447 communicate with a downstream-end annular chamber 73 which is delimited by O-rings 448, 449. The downstream-end annular chamber 73 emerges into the outlet connector 7 via, for example, a duct 72.

In the configuration of FIG. 7, the first radial orifices 446 are fluidically separated from the second radial orifices 358 by the O-ring 354.

In this manner, the continuity of the inlet channel is interrupted between the upstream and the downstream (see FIG. 14). Specifically, the upstream portion of the channel 211, the upstream annular chamber 441 and the upstream orifices 446 are in contact with the outside environment via the orifice(s) 219 of the upstream end of the spindle 21. On the other hand, the downstream annular chamber 359, the downstream orifices 358, the downstream portion 442 of the channel up to the outlet connector 7 are in fluidic connection with the user (not shown).

This configuration makes it possible on the one hand to protect the user circuit against external pollution and, on the other hand, to prevent a discharge of gas G coming from the user directly to the atmosphere (in the upstream direction).

In the configuration of FIGS. 8 and 15, the receiving device 700 is connected to a gas tank 300 via its dispenser (valve) 200. The dispenser 200 comprises a second closed isolation valve element 201 (preferably sealed).

As seen above, the receiving device 700 comprises, at its connection interface 2, L-shaped grooves 22 formed in the connecting flange 25. The movable locking ring 3, for its part, comprises housings 31. When the receiving device 700 is connected (coupled) to the gas dispenser 200 fitted with bayonets 202 (see FIG. 6), the receiving device 700 is presented and approached by the user so that the L-shaped grooves 22 of the connecting flange 25 correspond with said bayonets 202. A relative translation followed by a relative rotation of the receiving device 700 causes, once the bayonets 202 are in contact with the locking ring 3, the locking ring 3 to move back. When the bayonets 202 are positioned, the bent portion of the L-shaped groove, the locking ring 3, automatically returns to the upstream position via the action of the spring 24 in order to lock the bayonets 202 in the housings 23 of the ring 3 (see FIG. 2).

During this operation, the inlet spindle 21 moves into the body of the dispenser 200 while disengaging a first valve element or stopper 203 that is preferably sealed.

The inlet spindle 21 comes to be positioned in a sealed manner inside the gas dispenser 200 in at least one O-ring 204 supported by the dispenser 200.

Simultaneously, a surface 205 of the gas dispenser 200 (for example an outer cover) comes into contact with a terminal surface 34 of the stopper 35. This contact causes the movable stopper 35 to push in the downstream direction against the force of the return spring 355.

At the end of coupling, the stopper 35 is moved into a position in which the upstream radial orifices 446 and downstream radial orifices 358 of the movable inlet spindle 44 open into the same upstream annular chamber 351. This has the effect of then ensuring a continuity of the gas circuit from a chamber 206 situated inside the dispenser 200 to the outlet connector 7 (via the radial orifices 219 then the central channel 211 of the inlet spindle 21, then the upstream chamber 441, then the upstream radial orifices 446, then the upstream annular chamber 351, then the downstream radial orifices 358, then the downstream portion of the channel 442, then the radial orifices 447, then the annular chamber 73 and finally the channel 72).

The chamber 206 situated inside the dispenser 200 is for example a low-pressure chamber situated downstream of a gas relief valve incorporated into the dispenser. Moreover, the chamber 206 can be situated downstream of a second isolation valve element 201 placed in series with the first valve element 203.

In this configuration, any flow of gas passing through the chamber 206 of the dispenser 200 can be received and discharged via the circuit of the user while passing through the receiving device 700 (see FIG. 15).

Therefore, if the chamber 206 receives any gas escaping from a safety valve element of the dispenser 200, this high-pressure gas is discharged to the receiving device and then optionally to the user. Naturally it is possible to have the user 200 and/or the receiving device 700 comprise safety systems for handling this pressurized escape gas (secure discharges, additional safety valve elements etc). The escape gases may come, for example, from a safety component in communication with the gas contained in the tank 300 (gas escape valve opened on temperature and/or pressure information with respect to at least one determined threshold).

The inlet spindle 21, 44 may undergo a translation inside the receiving device 700. This translation is driven, for example, via the lever 4 having a rotation spindle 47 secured to the body 1.

It will be noted that this translation preferably has no effect on placing the upstream radial orifices 446 and downstream radial orifices 358 in communication via the upstream annular chamber 351 (specifically, the upstream annular chamber 351 is of a size to maintain the continuity between the upstream and downstream ends of the channel).

The lever 4 is in tangential contact 48 with the ring 43 screwed onto the inlet spindle 44. The rotation of the lever 4 in the appropriate direction causes the movable spindle 44 to move in the upstream direction. The rotation of the lever 4 can be controlled by an actuator 500 via a cable 501 connected to the lever 4, for example via a swivel joint 502.

The actuator 500 may be a device that is well known per se. The actuator 500 may notably be formed in order to pull the cable 501 in order to cause the rotation of the lever 4 and therefore the translation of the spindle 44 in response to a command from the user. For example, the user (engine/cell or other element) can command this translation in response to a measurement of a sensor and/or according to an automatic action and/or a triggering by a switch.

Preferably, by default (the cable 501 not being pulled), the actuator 500 is not operated. That is to say that the inlet spindle 21, 44 is by default in the downstream position of FIG. 7, because of the balance between the actions of the spring 42 in the downstream direction and of the spring 45 in the upstream direction.

In this position, the upstream end 207 of the stopper 203 (first valve element) housed in the dispenser 200 is pushed in the upstream direction by the upstream end of the movable spindle 44. But the stopper 203 is preferably of a size not to act on the second valve element 201 (isolation valve 201) placed further upstream in the dispenser 200 (see FIG. 15).

In this way, the second valve element 201 remains closed and prevents the pressurized gas G from coming from the tank 300 (unless, on the one hand, a safety valve element is open in the event of excessive temperature and/or pressure and the gas released by this safety valve element is directed into the chamber between the two valve elements 201 and 203).

This single open position (only the first valve element 203) can result in an emergency shutdown instruction to the actuator 500.

FIGS. 9 and 16 illustrate the receiving device 700 in a configuration connected to a tank 300 but in which the second isolation valve element 201 of the dispenser is also open.

For this, the actuator 500 is commanded and pulls on the cable 501 connected to the lever 4 via a swivel joint 502. This causes the lever 4 to rotate about its spindle 47 in the direction of pushing the ring 43 in the upstream direction (the ring 43 is screwed onto the inlet spindle 44 and the lever 4 being in tangential contact 48 with the ring 43).

The inlet spindle 21, 44 is then translated in the upstream direction 44. The upstream end of the inlet spindle 21, 44 then transmits by contact its movement to the stopper of the first valve element 203 which continues its travel in the upstream direction. The stopper of the first valve element 203 then acts by pushing on the second isolation valve element 201 and opens the latter.

The gas G contained in the tank 300 upstream of the second valve element 201 is released in the downstream direction. The gas passing through the open second valve element 201 then enters the low-pressure chamber 206 of the dispensing device 200 (between the two valve elements 201, 203). The gas then passes into the central channel 211 of the inlet spindle 21, 44 via radial orifices 219 of the inlet spindle. The gas then passes into the upstream chamber 441 and then into the upstream radial orifices 446 and downstream radial orifices 358 via the upstream annular chamber 351. The pressurized gas then continues its journey into the downstream portion of the channel 442 and emerges in the outlet connector 7 successively via the radial orifices 447, the annular chamber 73 and the channel 72.

The user 1600 (see FIG. 13) is therefore supplied with gas. In order to stop this gas supply, an instruction (functional or emergency) can be given to the actuator 500 to stop pulling the cable 501. When the force of the actuator is suppressed, the forces of the springs again place the receiving device 700 in the position of FIGS. 8 and 15. Similarly, if the cable 501 accidentally breaks, the receiving device 700 automatically returns to the position of FIGS. 8 and 15.

FIGS. 3 and 4 illustrate a variant embodiment of the receiving device 700. The elements that are identical to those described above with reference to FIGS. 1, 2 and 6 to 9 are designated by the same reference numbers and are not explained in detail a second time.

The embodiment of FIGS. 3 and 4 may relate more specifically to small gas cartridges. In this embodiment, the gas cartridge or bottle may for example be brought by the user inside a sheath 6 terminated by said receiving system (see FIG. 5).

As above, the receiving device 700 comprises a body 1 the downstream end of which comprises a connector 7 allowing a sealed connection to, for example, a circuit for supplying a user. The upstream end of the device 700 comprises a connection interface 2. The device 700 comprises a movable fluid inlet spindle 21 and a mechanical locking system 22 for the mechanical coupling.

According to the configuration of FIG. 10 or 14, the receiving device 700 is disconnected and at rest. The female connector 7 comprises, for example, a conical female tapping 71 allowing a sealed connection of the receiving system with the circuit for supplying a user (not shown). The connection flange 25 is prevented from rotating and connected to the body 1 via, for example, screws 256. The inlet spindle 21, 44 can move in translation inside the receiving device 700. This translation is driven, for example, by a rotary cam 4 having a rotation spindle 47 on the body 1 (see FIG. 4). The cam 4, via the pin 49, is in tangential contact 48 with the upstream portion of the inlet spindle 21. This upstream portion 21 of the inlet spindle is secured to the downstream inlet spindle 44 (here also each of the two inlet spindles 21, 44 or their association are designated by the generic term “inlet spindle” or simply “spindle”).

The position of the inlet spindle 21, 44 of FIG. 10 is normally stable by virtue of the resultant on the one hand of the force of the return spring 42 (in the downstream direction) and, on the other hand, of the force of the return spring 45 (in the upstream direction, see FIG. 4).

The inlet spindle 21, 44 comprises one or more inlet orifices 219 at its upstream end and is closed by the sealed plug 444 (O-ring 445) at its downstream end.

The upstream duct or channel 211 passing through the spindle 21, 44 opens into the upstream chamber 441 of the spindle 21, 44. The spindle 21, 44 comprises upstream radial orifices 446 at the upstream chamber 441. The upstream orifices 446 of the spindle 21, 44 communicate with an upstream annular chamber 351. The upstream annular chamber 351 is delimited by a spacer 353 and two O-rings 352, 354. The spacer 353 and the two O-rings 352, 354 are secured to a movable stopper 35. The stopper 35 can translate along the inlet spindle 21, 44.

In the stable position of FIG. 10, the return spring 355 pushes the stopper 35 against an abutment surface 212 of the inlet spindle 21, 44 (FIG. 14).

The stopper 35 comprises a second downstream annular chamber 359 delimited by the spacer 356 and the two O-rings 354, 357. The two annular chambers, the upstream chamber 351 and downstream chamber 359, are separated by an O-ring 354.

In the configuration of FIG. 10, the downstream radial orifices 358 of the spindle 21, 44 communicate with the downstream annular chamber 359 and open into the downstream portion of the channel 442 which is extended by the radial holes 447. The downstream radial holes of the spindle 21, 44 communicate with the annular chamber 73 which is delimited by the O-rings 448, 449. The annular chamber 73 opens into the outlet connector 7 via the duct 72.

In the configuration of FIG. 11, the receiving device 700 is connected to a tank 300 via a gas dispenser 200. The gas dispenser 200 (such as a valve) comprises a first sealed valve element or stopper 203 and a second isolation valve element 201.

As above, the gas dispenser 200 is fitted with bayonets 202 (see FIG. 6). The gas dispenser 200 is presented and approached by the user so that the bayonets 202 correspond with the L-shaped grooves 22 of the connection interface of the receiving device 700. A translation followed by a rotation of the dispenser 200 causes a mechanical connection with the receiving device 700. During this operation, the upstream end of the spindle 21, 44 moves into the dispenser 200 and pushes back the stopper of the first valve element 203 (see FIG. 15). The upstream end of the spindle 21, 44 is housed in a sealed manner inside the gas dispenser 200 in an O-ring 204.

The top cover 205 of the gas dispensing device 200 comes into contact with the surface 34 and pushes the movable stopper 35 against the force of the return spring 355. The stopper is moved so that the upstream radial orifices 446 and downstream radial orifices 358 of the inlet spindle 21, 44 open into the same upstream annular chamber 351.

In this configuration, there is a continuity of the gas circuit from the low-pressure chamber 206 of the dispenser 200 to the downstream portion of the channel 442 (the gas passes into the upstream portion of the channel 211 of the spindle 21, 44 via the upstream radial orifices 219, then into the upstream chamber 441, then via the radial orifices 446, 358 via the upstream annular chamber 351, then the downstream portion of the channel 442 opens into the outlet connector 7 via successively the radial orifices 447, the annular chamber 73 and the channel 72. Therefore, any flow of gas G passing through the low-pressure chamber 206 of the dispenser 200 is placed in communication with a user (see FIG. 15)).

As above, the low-pressure chamber 206 can collect any escape gas from a safety valve.

The translation of the inlet spindle 21, 44 is controlled via, for example, the cam 4 which rotates about the rotation spindle 47 secured to the body 1 (see FIG. 4).

As above, the translation of the spindle 21, 44 has no effect on placing the upstream radial orifices 446 and downstream radial orifices 358 in communication (the annular chamber 351 can be of a size to continue providing a connection between the upstream and downstream portions of the channel).

The cam 4 is in tangential contact 48 via a pin 49 with a contact surface 48 secured to the inlet spindle 21, 44. The rotation of the cam 4 causes selectively the movement of the inlet spindle 21, 44. The rotation of the cam 4 is controlled for example by an actuator 500 via a cable 501 connected to the cam 4 via a swivel joint 502. The actuator 500 may be a device which, on information from the user, may or may not pull the cable 501 in order to cause the selective rotation of the cam or lever 4 and therefore the translation of the inlet spindle 21, 44. By default (at rest, cable 501 not pulled), the actuator 500 is not operated. In this configuration, the position of the inlet spindle 21, 44 of FIG. 11 is stable because of the balance between, on the one hand, the force of the return spring 42 (force on the spindle 21, 44 in the downstream direction) and, on the other hand, the force of the return spring 45 (force on the cam 4 in the upstream direction, see FIG. 4).

In this position, the upstream end 207 of the stopper 203 is pushed in the upstream direction by the upstream end of the inlet spindle 21, 44. But in this first position, the spindle 21, 44 does not act on the second isolation valve element 201. This second isolation valve element 201 therefore remains closed (see FIG. 15). The gas G coming from the tank 300 (except in the optional case of a safety escape) is therefore not delivered to the receiving device 700.

This rest position is the default safety position (it can notably result from an emergency shutdown controlled by the actuator 500).

FIGS. 12 and 16 illustrate the receiving device 700 connected to the dispenser 200 of a tank 300 with the second isolation valve element 201 open.

That is to say that the actuator 500 pulls on the cable 501 connected to the cam 4 so as to rotate the cam 4 about the spindle 47 (see FIG. 4). Since the cam 4 is in tangential contact 48 via the pin 49 with the spindle 21, 44, the latter is moved so as to push the first valve element 203 in the upstream direction. The upstream end of the first valve element 203 which then acts on the second valve element 201 and thus opens the latter.

In this manner, the pressurized gas G can travel from upstream to downstream from the second valve element 201 to the low-pressure chamber 206. The gas can then enter the central channel 211 of the inlet spindle 21, 44 via the radial orifices 219, then the upstream chamber 441. Since the upstream radial orifices 446 and downstream radial orifices 358 are placed in communication by the upstream annular chamber 351, the gas continues its journey into the downstream portion of the channel 442 and emerges in the outlet connector 7. The user situated downstream of the connector 7 is therefore supplied with pressurized gas.

To stop this gas supply, an instruction (functional or emergency) can be given to the actuator 500 to stop pulling the cable 501. The receiving device then returns to the “single open” position of FIGS. 11 and 15. Similarly, if the cable 501 breaks, the receiving device 700 automatically returns to the position of FIG. 11 (only the first valve element 203 is open).

FIG. 13 shows an example of application of the invention comprising several gas tanks 300. Each tank 300 is connected to the circuit 600 for supplying a user 1600 via a respective gas dispenser 200 connected to a respective receiving device 700. Each receiving device 700 is controlled by a respective actuator 500. The actuators 500 can be operated by a management member 550 which, via the receiving devices 700, coordinates the opening or closing of the valve elements 201 of the dispensers. Therefore, for example, the gas supply of the application can be achieved by a sequential emptying of the tanks 300. Moreover, an emergency shutdown causing the closure of all the valve elements 201 of the tanks 300 is possible.

According to a particular possible advantageous feature, the dispenser 200 (or valve) may comprise a safety valve designed to be subjected to the pressure in the tank in order selectively to close or open a passageway for the gas from the tank to a discharge zone according to the temperature and/or the pressure of the gas in the tank with respect to at least one determined threshold. Advantageously, the discharge zone of the safety valve is situated between the first valve element 203 and second valve element 201.

In this way, the escape gas which may be released is retained by default in the dispenser (first valve element 203 closed) but is collected by the receiving device when it is connected (sealed opening of the first valve element 203).

1-12. (canceled)

13. A receiving device for pressurized gas, comprising a connection interface comprising at least one coupling member adapted to interact selectively in coupling with a coupling member joined to a gas dispenser, the receiving device comprising a movable gas inlet spindle defining a flow channel for the gas, said channel having at least one downstream end designed to be connected to a gas consuming device and one upstream end designed to be connected to a gas dispenser, the inlet spindle being selectively movable relative to the coupling member between at least two stable positions: a first downstream reference position and a second position advanced in the upstream direction, wherein:
the receiving device comprises a stopper that is selectively movable relative to the inlet spindle between a first position interrupting the flow of gas between the upstream end and downstream end of the channel, and a second position allowing the flow of gas between the upstream end and downstream end of the channel.

14. The device of claim 13, wherein the movable stopper is by default automatically forced toward its first position.

15. The device of claim 13, wherein the movable stopper is formed so as to be moved toward its second position by direct or indirect mechanical contact with a gas dispenser and/or manually and/or by a remote-control actuator.

16. The device of claim 13, wherein the movable stopper is configured to be moved automatically toward its second position when the receiving device is coupled to a gas dispenser.

17. The device of claim 13, wherein the flow channel comprises two separate distinct portions having ends fluidically communicating therebetween, the stopper forming a movable linking chamber selectively placing or not placing ends of the two portions of the channel in fluidic communication.

18. The device of claim 13, wherein the inlet spindle can be moved in translation between the first downstream reference position and the at least second, advanced upstream, position under the action of a lever or of an operating cam.

19. The device of claim 13, wherein the inlet spindle is, by default, forced toward its first downstream reference position by a return member.

20. An assembly comprising a dispenser of pressurized gas comprising a coupling member, and the receiving device of claim 13, wherein:
the gas dispenser comprises a circuit for dispensing gas to the receiving device furnished with a first sealed valve element or stopper and a second valve element placed in series, and
the inlet spindle is of a size such that, when the receiving device is in the coupling position on the gas dispenser, the first sealed valve element or stopper of the gas dispensing circuit is actuated to open by the inlet spindle placed in its first downstream reference position, or respectively the first valve element of the gas dispensing circuit is actuated to open by the inlet spindle only when the latter is placed in its second upstream reference position.

21. The assembly of claim 20, wherein the inlet spindle is of a size such that, when the receiving device is in the coupling position on the gas dispenser and the inlet spindle is moved into its second position advanced in the upstream direction, the latter also opens the second valve element of the gas dispensing circuit.

22. The assembly of claim 20, wherein the first valve element and second valve element are, by default, forced into their closed position by return members.

23. The assembly of claim 20, wherein, when the receiving device is in the coupling position on the gas dispenser and the inlet spindle is in its first downstream reference position, a sealing system supported by the receiving device and/or the dispenser forms a sealed barrier between the gas dispensing circuit and the outside and allows gas to travel from the gas dispensing circuit of the dispenser to the inlet spindle of the receiving device in a sealed manner with respect to the outside.

24. A system for supplying pressurized gas to a gas user from at least one pressurized gas tank, each tank comprising a pressurized gas dispenser such as a valve, the user being able to be selectively connected to each dispenser via a respective receiving device, characterized in that the assembly or assemblies each comprising a gas dispenser and a receiving device comply with claim 20.

25. The receiving device for pressurized gas of claim 13, wherein the gas consumption device comprises an engine or a fuel cell.

26. The device of claim 14, wherein the movable stopper is by default automatically forced toward its first position via a return element.

27. The assembly of claim 20, wherein the dispenser of pressurized gas is a valve.

28. The system of claim 24, wherein the pressurized gas dispenser is a valve.
